(19) United States
(12) Patent Application Publication
(10) Pub. No.: US 2022/0316266 A1
(43) Pub. Date: Oct. 6, 2022

(54) REINFORCED STRUCTURE AT BOTTOM OF GLASS DOOR

(71) Applicant: EPCO ARCHITECTURE HARDWARE (TAIWAN) CORP., Taipei (TW)

(72) Inventor: Chun-Chou KAO, Taoyuan (TW)

(21) Appl. No.: 17/700,718

(22) Filed: Mar. 22, 2022

(30) Foreign Application Priority Data
Mar. 24, 2021 (TW) 110110623

(51) Int. Cl. E06B 7/28; E06B 3/02; E05B 65/00

(52) U.S. Cl. CPC E06B 7/28; E06B 3/02; E05B 65/0025; E05D 7/081

(57) ABSTRACT

A reinforced structure at a bottom of a glass door is provided. The bottom of the glass door is assembled with a reinforced structure comprising a reset device assembled on a side thereof; two cushioning materials connected and fixed on one side of the reset device respectively, wherein the two cushioning materials are respectively provided with a locking portion on one side opposite to the direction of the reset device; and two outer protective covers sleeved on outer surfaces of the reset device and the two cushioning materials respectively. The bottom of the glass door is protected, reinforced and cushioned by the reinforced structure from kicking by user's foot when walking or moving objects or colliding by the wheelchair to break the glass of the glass door or cause an easy bend by wind, and the reinforced structure can be applied to a wider glass door.

### FIELD OF THE INVENTION

The invention provides a reinforced structure, particularly a reinforced structure at a bottom of a glass door.

### BACKGROUND OF THE INVENTION

Referring to a bottom structure of a conventional glass door in FIG. 1 and FIG. 2, a first notch 111 on one side of a bottom 11 of a glass door 1 is provided to assemble a restoring device 12, a second notch 112 on the other side is provided to assemble a lock 13, and no reinforcing material is provided between the first notch 111 and the second notch 112 on the bottom 11 of the glass door 1. When using the glass door 1, the assembly of the glass door 1 is facilitated by a shaft lever 121 protruding from the bottom end surface of the reset device 12, a shaft hole is provided in a door frame (not shown) of the glass door 1 corresponding to a position of the shaft lever 121, the shaft hole forms an open or closed state for easy assemble of the glass door 1.

While using the conventional glass door 1, since the glass door 1 is usually assembled at the inner position of the door frame, the bottom 11 of the glass door 1 is weaker if the length thereof is longer. In addition, the center of the first notch 111 and the second notch 112 located at the bottom 11 of the glass door 1 are not protected by reinforcing materials, so that the bottom 11 of the glass door 1 does not have a reinforcing and buffering function. The glass door 1 is fragile when a user wants to open or close the glass door 1, the user kicks the center of the bottom 11 of the glass door 1 by foot when walking, kicks by foot when moving objects or collides by wheelchair. The center of the bottom 11 of the glass door 1 is easily bent if it is blown by wind. Those problems need for further improvement.

### SUMMARY OF THE INVENTION

The main object of the invention is to solve the problems from the bottom of the conventional glass door.

In order to achieve the above object, the invention provides a reinforced structure at a bottom of a glass door, wherein the bottom of the glass door is assembled with the reinforced structure. The reinforced structure comprises a reset device assembled on a side of the bottom of the glass door; two cushioning materials respectively connected and fixed on a side of the reset device, wherein a side of each of the two cushioning materials opposite to the reset device are respectively provided with a locking portion; and two outer protective covers respectively sleeved on outer surfaces of the reset device and respectively sleeved on outer surfaces of the two cushioning materials.

Furthermore, the two locking portions is a locking shell formed by assembling two shells; wherein each of the two cushioning materials is a single cushioning material, or each of the two cushioning materials is connected with one of the two shells, or each of the two cushioning materials is a plurality of cushioning members comprising a first cushioning member and two second cushioning members; and wherein a combination between the two cushioning materials and the reset device, between the two cushioning materials and the two shells, between the first cushioning member and the two second cushioning members, or between the two first cushioning members, the two second cushioning members and the two shells is connected by a connection type of embedding, clamping, splicing, lapping, or a combination thereof.

Furthermore, the side of the bottom of the glass door is provided with a first embedding notch; or the side of the bottom of the glass door is provided with the first embedding notch, an other side of the bottom of the glass door is provided with a second embedding notch, and the second embedding notch is assembled and fixed with the locking shell; wherein the reset device is provided with a surrounding groove which is assembled with the first embedding notch of the bottom of the glass door, the side of the reset device facing the glass door is separated by the surrounding groove and formed two joining edges, and the two joining edges are respectively provided with a concave portion; wherein both sides of the two cushioning materials are provided with two clamping grooves respectively located on an upper side and a lower side, and an upper edge and a lower edge of the two clamping grooves facing inner and outer surfaces of the glass door respectively forms an inclined surface; or both an upper side and a lower side of the two second cushioning members provide two clamping groove, the upper edge and the lower edge of the clamping groove facing the inner and outer surfaces of the glass door respectively forms an inclined surface, the two locking portions are respectively provided with a through hole and a plurality of holes, the plurality of holes of the two locking portions are respectively penetrated by a plurality of fixing pieces so as to fix the two cushioning materials, an other side of each of the two cushioning materials facing the concave portions of the two joining edges is respectively provided with a convex portion; the convex portions are embedded and confined in the concave portions, and the two cushioning materials are respectively combined with and connected to the reset device; or the two shells are respectively provided with an another concave portion facing the side of the two cushioning materials; the two shells are respectively provided with a through hole and a plurality of holes, and a plurality of fixing pieces respectively penetrates into the plurality of holes of the two shells to fix the locking shell; or the two cushioning materials are respectively provided with an another convex portion on the side opposite to the reset device, and the convex portions at both sides of the two cushioning materials are respectively embedded and confined in the concave portions of the reset device and the another concave portions of the two shells, the two cushioning materials are respectively combined and connected with the reset device and the locking shells; and a receptacle and a strong magnet therein are provided on an inner surface of each of the two cushioning materials or each of the first cushioning members such that the two cushioning materials or the first cushioning members are closely fitted on the inner and outer surfaces of the bottom of the glass door by each of the strong magnets; and wherein the two outer protective covers are respectively provided with a frame edge, and a side of the frame edge facing the two cushioning materials is provided with an inner space; and both sides of the inner space are respectively provided with a catching piece, outer ends of the catching pieces are respectively provided with an insertion portion, the insertion portion is slightly curved outwards, and the insertion portions are respectively inserted into and clamped by each of the clamping grooves of the two cushioning materials or the two second cushioning members.

Furthermore, a lock is assembled between the two shells, the lock comprises a rotary lock and a lock sleeve, the rotary lock protrudes from the through hole of one of the two shells, and the plurality of fixing pieces are respectively inserted into the plurality of holes of the two shells to fix the lock; and wherein an end of each of the two outer protective covers facing the rotary lock and the lock sleeve is provided with an opening, the rotary lock protrudes from and is positioned by one of the openings of the two outer protective covers, and the lock sleeve is inserted and fixed by another one of the openings of the two outer protective covers.

Furthermore, both sides of the first cushioning members are respectively provided with a concave portion, and both sides of the two second cushioning members are respectively provided with a convex portion; several of the convex portions are embedded and confined in the concave portions of the first cushioning members, the two second cushioning members are respectively combined with and connected to the first cushioning members; and several of the convex portions are embedded and confined in the concave portions of the reset device and the concave portions of the two shells, the two second cushioning members are respectively combined with and connected to the reset device and the two shells.

Furthermore, wherein the reinforced structure further comprises two cushions respectively provided on outer surfaces of the reset device and the two cushioning materials, or on outer surfaces of the reset device, the two cushioning materials and the two shells.

Furthermore, the two cushions are single pieces, lengths of the two cushions are respectively provided with the outer surfaces of the reset device and the two cushioning materials; the two cushions are respectively provided with a notch hole and a plurality of fixing holes, the notch holes respectively correspond to the through holes of the locking portions or the through holes of the two shells, and the plurality of fixing holes respectively correspond to the plurality of holes of the locking portions or the plurality of holes of the two shells; two embedding grooves are respectively provided on an upper side and a lower side and are provided on both sides of the two cushions, the two embedding grooves corresponds to the two clamping grooves of the two cushioning materials, the insertion portions of the two catching pieces are respectively inserted into and clamped by each of the two embedding grooves of the two cushions and each of the two clamping grooves of the two cushioning materials.

Furthermore, each of the two cushions is a plurality of pieces, the plurality of pieces comprise a first gasket, a second gasket and at least one third gasket; a length of the first gasket is provided according to a length of outer surface of the two cushioning materials, a length of the second gasket is provided according to a length of outer surfaces of the locking portions of the two cushioning materials or outer surfaces of the two shells; the second gasket is provided with a notch hole and a plurality of fixing holes, the notch holes respectively correspond to the through holes of the locking portions or the through holes of the two shells, and the plurality of fixing holes respectively correspond to the plurality of holes of the locking portions or the plurality of holes of the two shells; a length and a position of the third gasket are provided according to outer surface of the reset device; and two embedding grooves are respectively provided on an upper side and a lower side and are provided on both sides of the first gaskets, the two embedding grooves corresponds to the two clamping grooves of the two cushioning materials, the insertion portions of the two catching pieces are respectively inserted into and clamped by each of the two embedding grooves of the first gaskets and each of the two clamping grooves of the two cushioning materials.

Furthermore, the two cushioning materials are made of a plastic material.

In view of the foregoing, the invention has following features compared to the conventional technique. The invention provides a reinforced structure at a bottom of a glass door, and the bottom of the glass door is protected from direct impact by the reinforced structure, and the user avoids breaking the glass of the glass door when kicking the bottom of the glass door by the foot while walking, by the foot while moving objects, colliding by the wheelchair, or bending easily by wind, so that the bottom of the glass door is reinforced and cushioned.

The reinforced structure of the invention can be applied to a wider glass door, and the lengths of the cushioning materials are provided according to the door width of the glass door required by the user, so as to speed up assembling process and save molding costs.

### BRIEF DESCRIPTION OF THE DRAWINGS

FIG. 1 is an exploded perspective view of a bottom structure a conventional glass door.

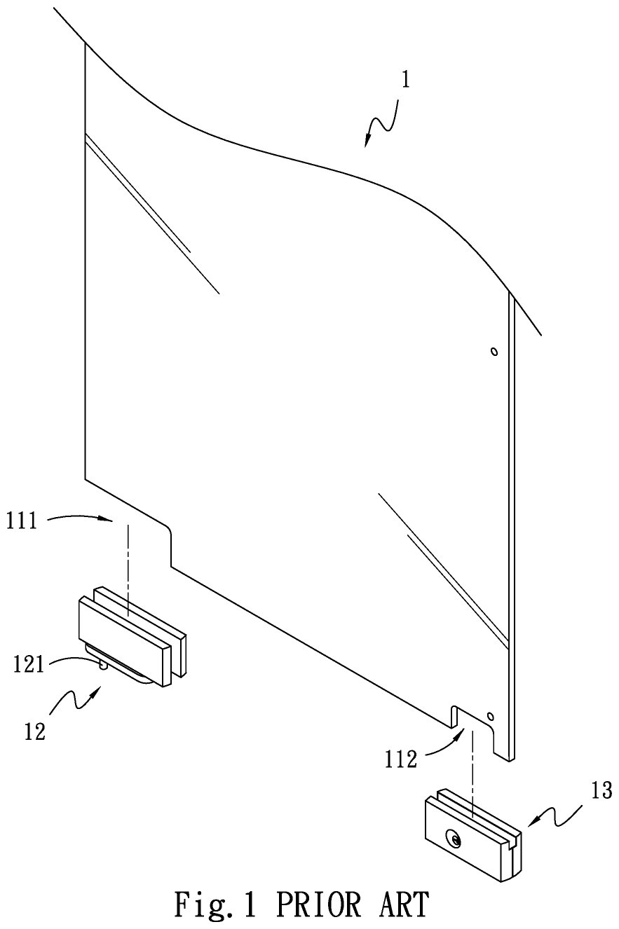

FIG. 2 is a perspective view of a bottom structure for the glass door in FIG. 1.

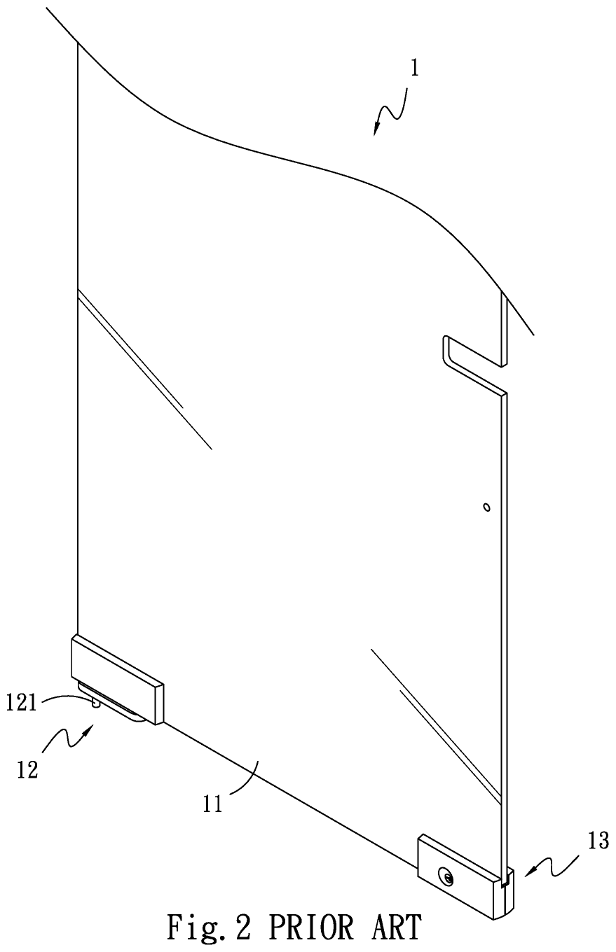

FIG. 3 is an exploded perspective view of a glass door and a reinforced structure at a bottom of the glass door according to the invention.

FIG. 4 is an exploded perspective view of the reinforced structure at the bottom of the glass door in FIG. 3 wherein a cushioning material is a single cushioning material.

FIG. 5 is a cross-sectional side view of an outer protective cover sleeved and clamped into the cushioning material in FIG. 3.

FIG. 6 is a cross-sectional side view of the cushioning material in FIG. 3 in combination with a strong magnet.

FIG. 7 is a perspective view of FIG. 3.

FIG. 8 is an exploded perspective view of the reinforced structure at the bottom of the glass door in FIG. 3 wherein cushions are single pieces.

FIG. 9 is an exploded perspective view of the reinforced structure at the bottom of the glass door in FIG. 3 wherein each of the cushions is a plurality of pieces.

FIG. 10 is an exploded perspective view of the cushioning material of the reinforced structure at the bottom of the glass door in FIG. 3 combined with a locking shell.

FIG. 11 is an exploded perspective view of the cushioning material of the reinforced structure at the bottom of the glass door in FIG. 10 combined with the locking shell.

FIG. 12 is an exploded perspective view of the reinforced structure at the bottom of the glass door in FIG. 10 wherein cushions are single pieces.

FIG. 13 is an exploded perspective view of the reinforced structure at the bottom of the glass door in FIG. 12 configured with a single piece of cushion.

FIG. 14 is an exploded perspective view of the reinforced structure at the bottom of the glass door in FIG. 12 wherein each cushions is a plurality of pieces.

FIG. 15 is an exploded perspective view of another embodiment of the reinforced structure at the bottom of the glass door configured with a lock according to the invention.

FIG. 16 is an exploded perspective view of the reinforced structure at the bottom of the glass door in FIG. 15.

FIG. 17 is a perspective view of FIG. 16.

### DETAILED DESCRIPTION OF THE PREFERRED EMBODIMENTS

How the structure of the invention is assembled and used is described with figures in detail below, so as to make it easier to understand the purpose, technical content, characteristics, and the effects of the invention.

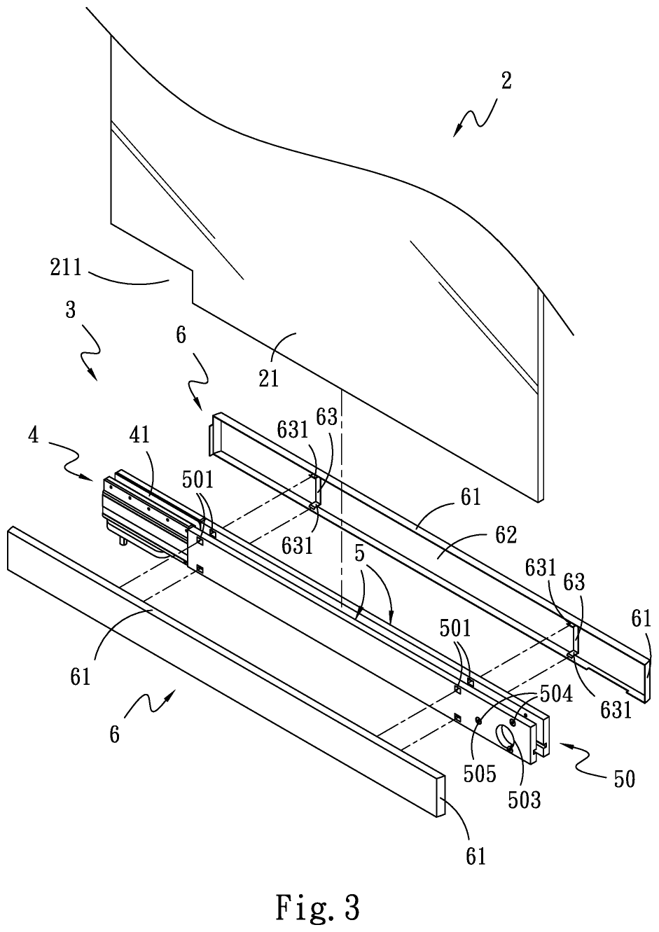

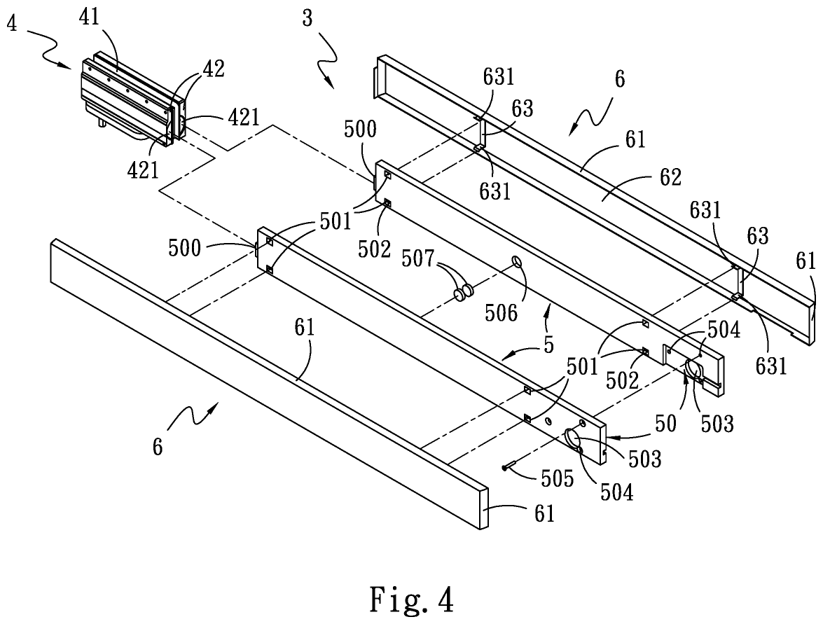

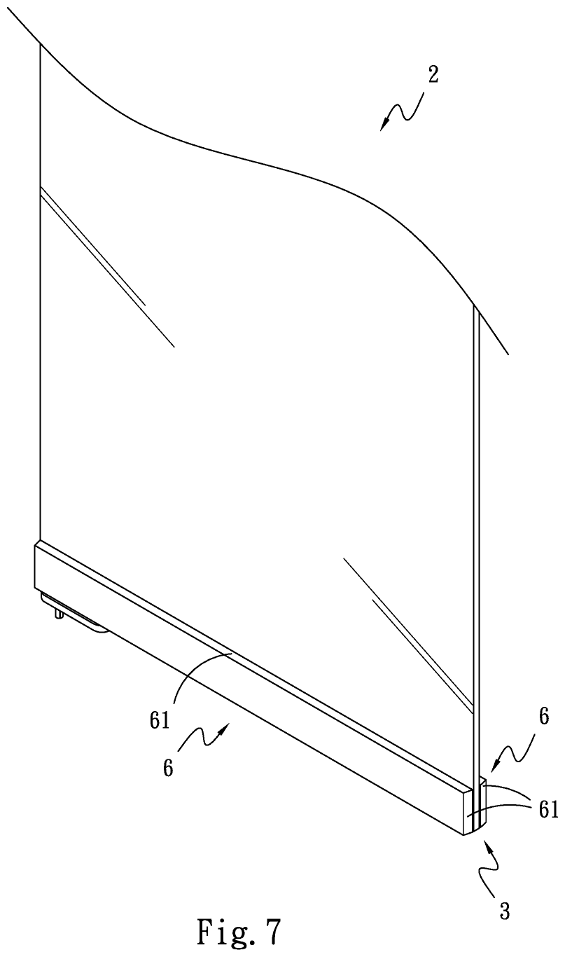

Referring to FIG. 3, FIG. 4 and FIG. 7, the invention is a reinforced structure at a bottom of a glass door, wherein a bottom 21 of the glass door 2 is assembled with a reinforced structure 3 comprising a reset device 4, two cushioning materials 5 and two outer protective covers 6.

With reference to FIG. 3 and FIG. 4, the reset device 4 is provided with a surrounding groove 41 which is assembled with a first embedding notch 211 of the bottom 21 of the glass door 2; the side of the reset device 4 facing the glass door 2 is separated by the surrounding groove 41 and formed two joining edges 42; and the two joining edges 42 are respectively provided with a concave portion 421. The glass door 2 is restores itself by oil pressure, air pressure or a spring.

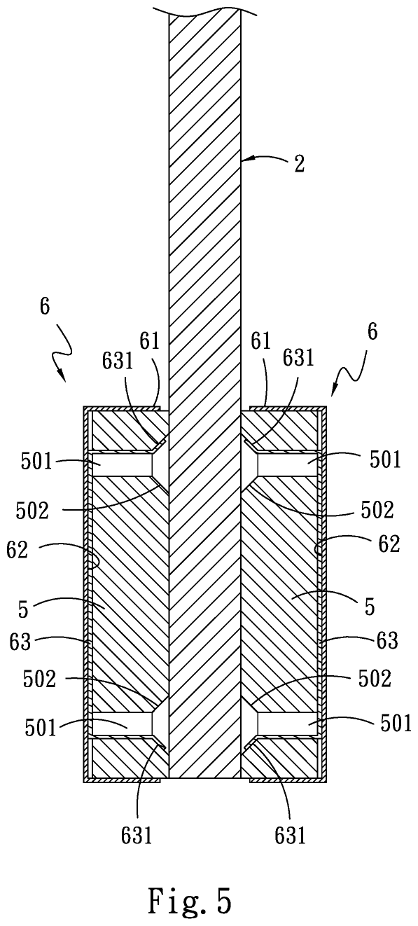

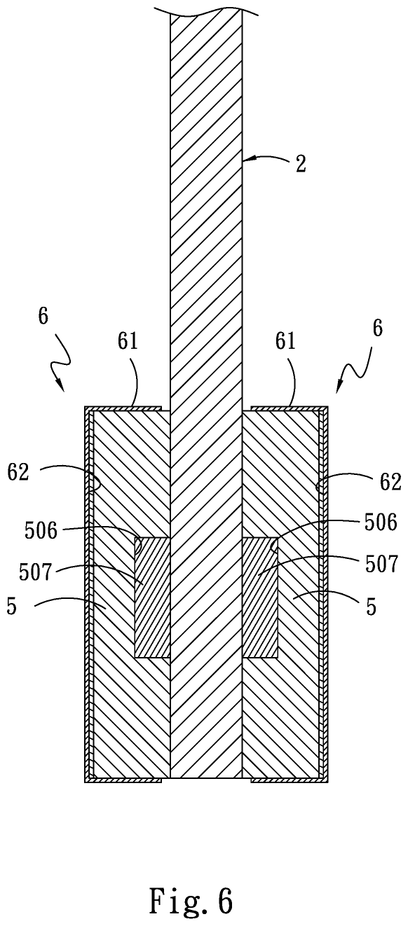

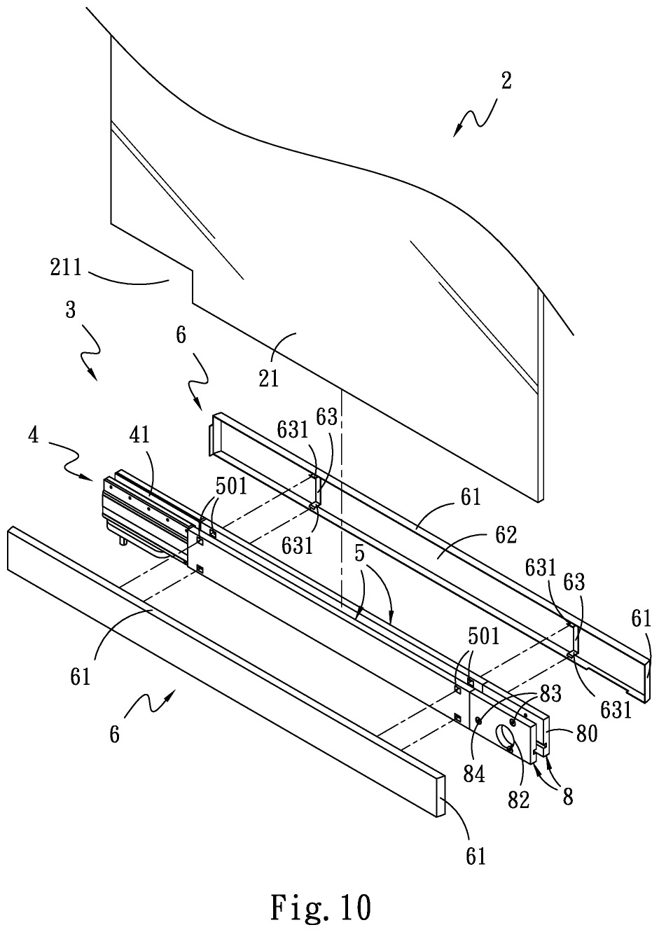

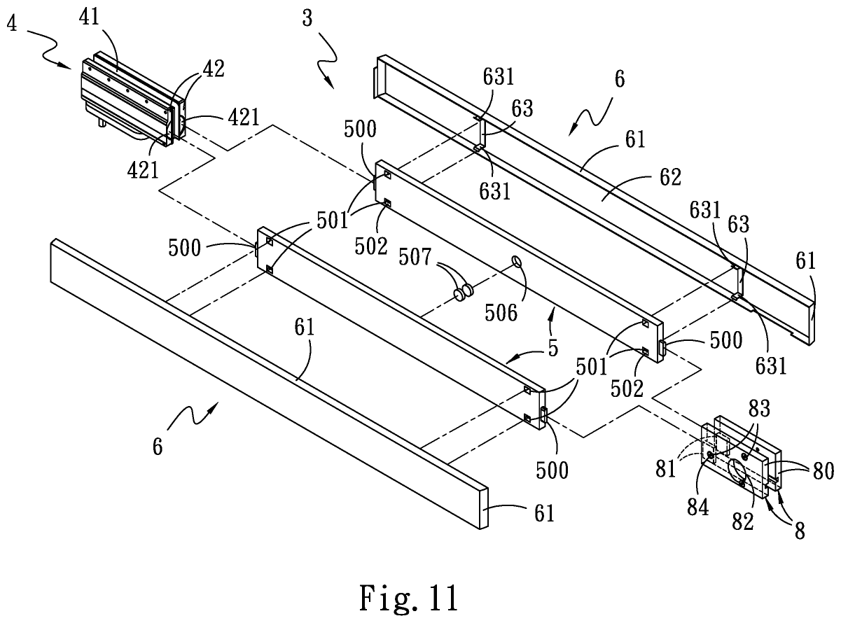

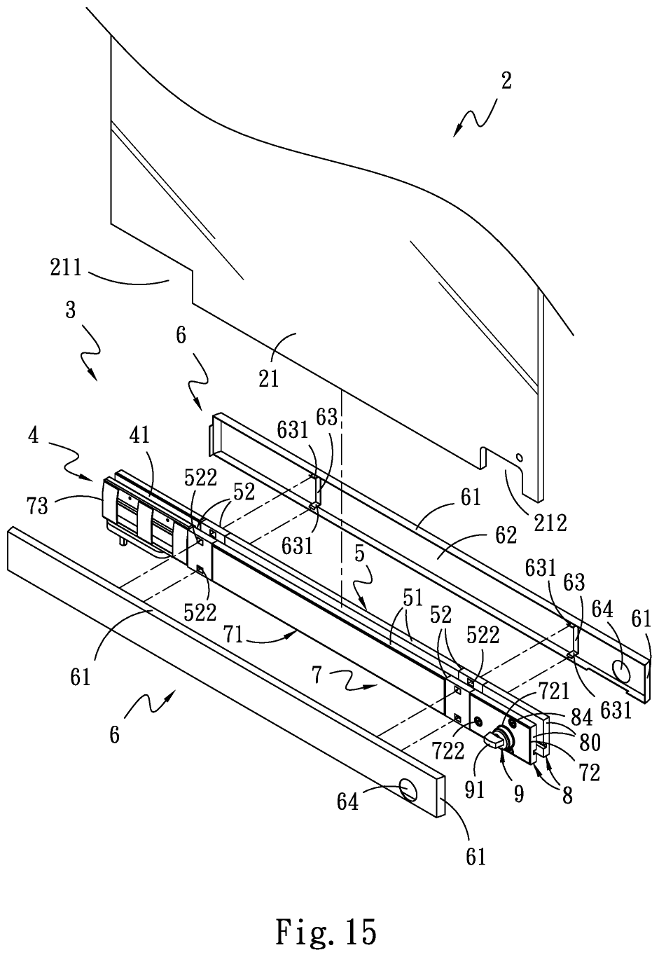

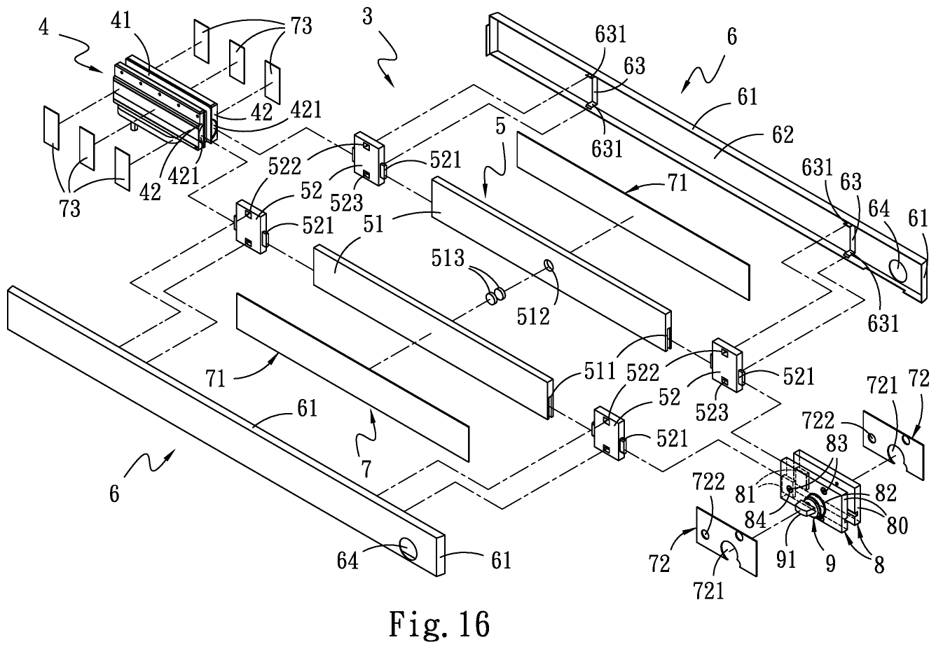

With reference to FIG. 3 and FIG. 4, two cushioning materials 5 are respectively connected and fixed on a side of the reset device 4, and a side of each of the two cushioning materials 5 opposite to the reset device 4 are respectively provided with a locking portion 50. The two locking portions 50 are a locking shell 8 formed by assembling two shells 80, as shown in FIG. 10 and FIG. 11. The two cushioning materials 5 are made of a plastic material, each of the two cushioning materials 5 is a single cushioning material; or each of the two cushioning materials 5 is connected with one of the two shells 80 as in FIGS. 10 and 11; or each of the two cushioning materials 5 is a plurality of cushioning members as in FIGS. 15 and 16, and the plurality of cushioning members respectively comprises a first cushioning member 51 and two second cushioning members 52. A combination between the two cushioning materials 5 and the reset device 4, between the two cushioning materials 5 and the two shells 80, between the first cushioning members 51 and the two second cushioning members 52, or between the first cushioning members 51, the two second cushioning members 52 and the two shells 80 is connected by a connection type of embedding, clamping, splicing, lapping, or a combination thereof. With reference to FIG. 3 and FIG. 4, both sides of the two cushioning materials 5 are provided with two clamping grooves 501 respectively located on an upper side and a lower side, and an upper edge and a lower edge of the two clamping grooves 501 facing inner and outer surfaces of the glass door 2 respectively forms an inclined surface 502, as shown in FIG. 5. The two locking portions 50 are respectively provided with a through hole 503 and a plurality of holes 504, the plurality of holes 504 of the two locking portions 50 are respectively penetrated by a plurality of fixing pieces 505 so as to fix the two cushioning materials 5. An other side of each of the two cushioning materials 5 facing the concave portions 421 of the two joining edges 42 is respectively provided with a convex portion 500, the convex portions 500 are embedded and confined in the concave portions 421, and the two cushioning materials 5 are respectively combined and connected to the reset device 4. A receptacle 506 and a strong magnet 507 therein are provided on an inner surface of each of the two cushioning materials 5, and the two cushioning materials 5 are more closely fitted on the inner and outer surfaces of the bottom 21 of the glass door 2 by each of the two strong magnets 507, so that there is no gap between the two cushioning materials 5 and the inner and outer surfaces of the bottom 21 of the glass door 2 as in FIG. 6.

Referring to FIG. 3 and FIG. 4, the two outer protective covers 6 are respectively sleeved on outer surfaces of the reset device 4 and respectively sleeved on outer surfaces of the two cushioning materials 5; the two outer protective covers 6 are respectively provided with a frame edge 61; a side of the frame edge 61 facing the two cushioning materials 5 is provided with an inner space 62; and both sides of the inner space 62 are respectively provided with a catching piece 63; outer ends of the catching pieces 63 are respectively provided with an insertion portion 631 which is slightly curved outwards, and the insertion portions 631 are respectively inserted into and clamped by each of the clamping grooves 501 of the two cushioning materials 5. Thereby, the bottom 21 of the glass door 2 is protected by arranging the cushioning materials 5 through the reinforced structure 3, so that the bottom 21 of the glass door 2 is not directly collided, and the user can avoid colliding the bottom 21 of the glass door 2 by the foot or the wheelchair when walking or moving objects to break the glass of the glass door 2 or to be easily bended by wind, thereby increasing the reinforcing and cushioning effect of the bottom 21 of the glass door 2.

Referring to FIG. 10 and FIG. 11, the two shells 80 are respectively provided with a concave portion 81 facing a sides of the two cushioning materials 5, and the two shells 80 are respectively provided with a through hole 82 and a plurality of holes 83, the plurality of holes 83 of the two shells 80 are respectively penetrated by a plurality of fixing pieces 84 so as to fix the locking shell 8. An other side of each of the two cushioning materials 5 opposite to the reset device 4 are respectively provided with a convex portion 500, so that the convex portions 500 on both sides of the two cushioning materials 5 are embedded and confined in the concave portions 421 of the reset device 4 and the concave portions 81 of the two shells 80, so that the two cushioning materials 5 are respectively combined with and connected to the reset device 4 and the two shells 80.

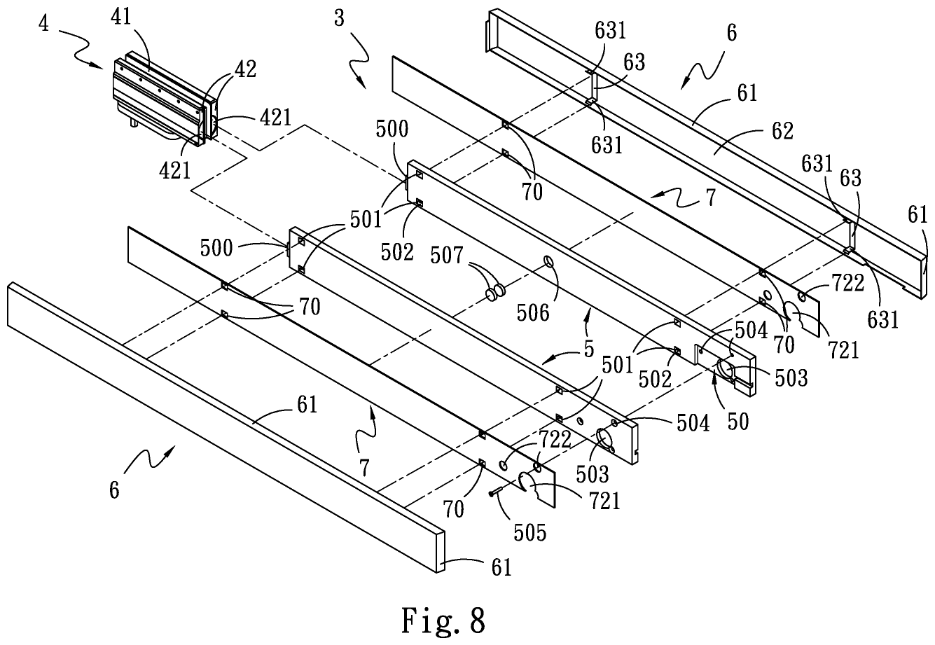

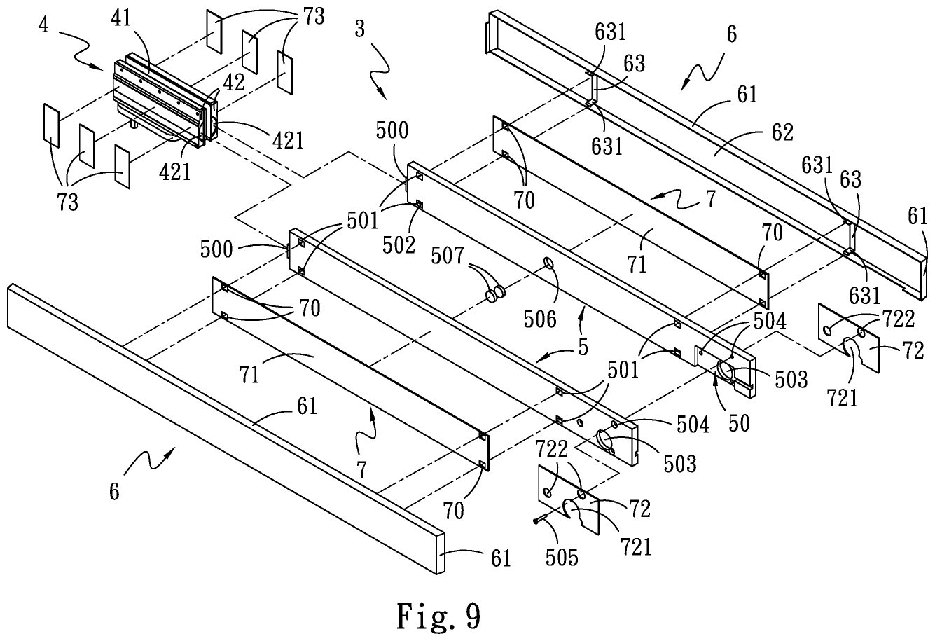

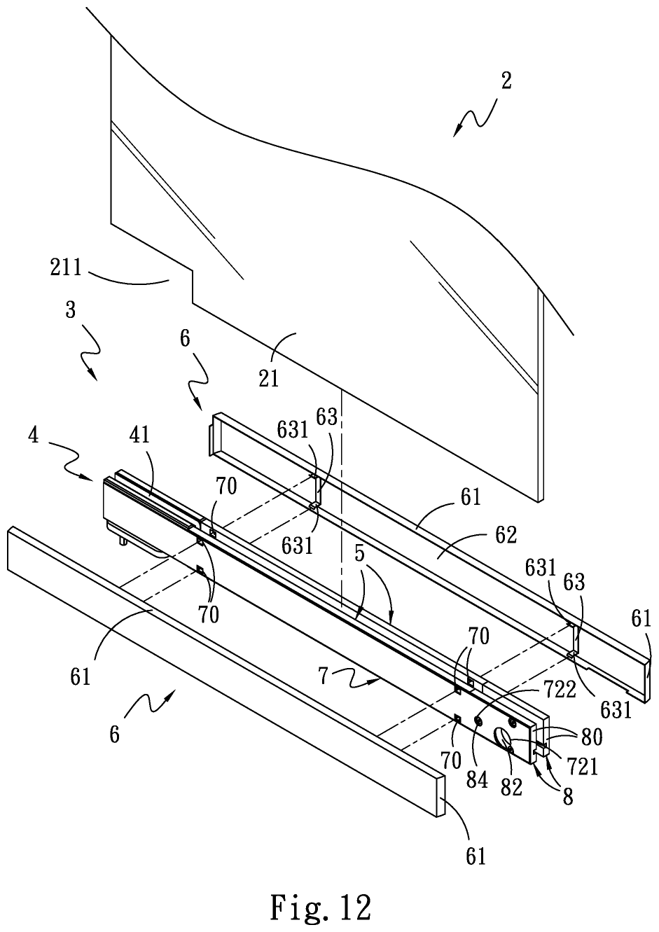

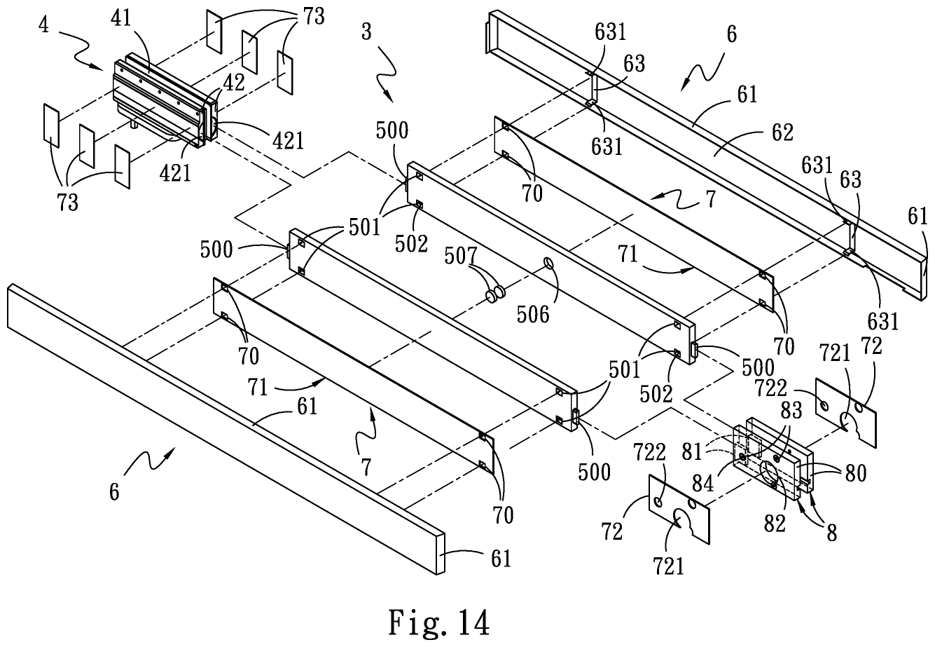

With reference to FIG. 8, the reinforced structure 3 further comprises two cushions 7 respectively provided arranged on outer surfaces of the reset device 4 and the two cushioning materials 5, or respectively on outer surfaces of the reset device 4, the two cushioning materials 5 and the two shells 80, as shown in FIG. 12. The two cushions 7 are single pieces as shown in FIG. 8 and FIG. 12, or a plurality of pieces as shown in FIG. 9, FIG. 14 and FIG. 15. The structure of the two cushions 7 is described below.

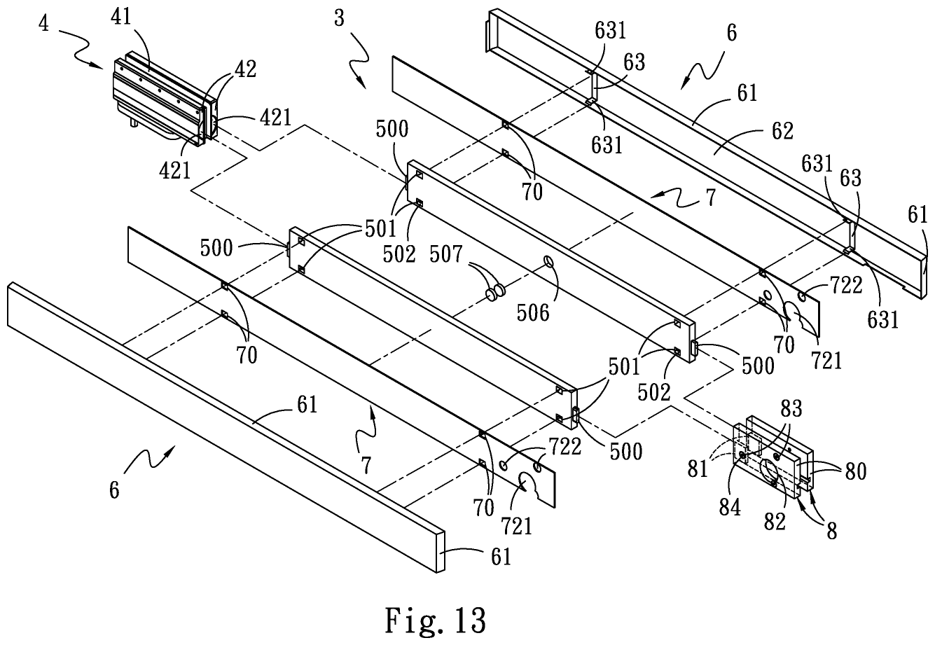

With reference to FIG. 8, FIG. 12 and FIG. 13, the lengths of the two cushions 7 are respectively provided with the outer surfaces of the reset device 4 and the two cushioning materials 5; the two cushions 7 are respectively provided with a notch hole 721 and a plurality of fixing holes 722, the notch hole 721 respectively correspond to the through holes 503 of the locking portions 50 or the through holes 82 of the two shells 80, the plurality of fixing holes 722 respectively correspond to the plurality of holes 504 of the locking portions 50 or the plurality of holes 83 of the two shells 80; and the plurality of fixing holes 722 are respectively penetrated by the plurality of fixing pieces 505.

Referring again to FIG. 9 and FIG. 14, the plurality of pieces of cushions 7 comprise a first gasket 71, a second gasket 72 and at least one third gasket 73; the length of the first gasket 71 is provided according to a length of outer surfaces of the two cushioning materials 5. A length of the second gasket 72 is provided according to a length of outer surfaces of the locking portions 50 of the two cushioning materials 5; the two second gaskets 72 are respectively provided with the notch holes 721 and the plurality of fixing holes 722, the notch holes 721 correspond to each of the through holes 503 of the locking portions 50 or each of the through holes 82 of the two shells 80; the plurality of fixing holes 722 correspond to each of the plurality of holes 504 of the locking portions 50 or each of the plurality of holes 83 of the two shells 80; and the plurality of fixing pieces 505 pass through the plurality of fixing holes 722 to fix the second gaskets 72 on outer surfaces of the locking portions 50 of the two cushioning materials 5. A length of the third gasket 73 is provided according to outer surface of the reset device 4. In this embodiment, the third gaskets 73 are each three-piece assembled and a position thereof is provided according to outer surface of the reset device 4. Two embedding grooves 70 are respectively provided on an upper side and a lower side and are provided near both sides of the two cushions 7 or the first gaskets 71, the insertion portions 631 of the two catching pieces 63 are respectively inserted into and clamped by each of the two embedding grooves 70 of the two cushions 7 or the first gaskets 71 and each of the two clamping grooves 501 of the two cushioning materials 5.

Referring to FIG. 12 and FIG. 13, the reinforced structure 3 is provided with the two cushions 7 as single pieces on outer surfaces of the reset device 4, the two cushioning materials 5 and the locking shell 8, respectively, or provided with the two cushions 7 as a plurality of pieces as shown in FIG. 14, wherein the two cushions 7 are as the two cushions 7 described in FIG. 8, and the plurality pieces of cushions 7 are as the plurality pieces of cushions 7 described in FIG. 9, which will not be described further herein.

Referring again to FIG. 15 and FIG. 16, the structure of the bottom 21 of the glass door 2 is as the aforementioned third embodiment, wherein the side of the bottom 21 of the glass door 2 is provided with the first embedding notch 211, and an other side of the bottom 21 of the glass door 2 is provided with a second embedding notch 212. In this embodiment, the plurality of cushioning members respectively comprises two cushioning members, the two cushioning members respectively comprises a first cushioning member 51 and a second cushioning member 52, both sides of the two first cushioning members 51 are respectively provided with a concave portion 511, and opposite sides of the two first cushioning members 51 are respectively provided with a receptacle 512 receiving a strong magnet 513; and the two first cushioning members 51 are more closely fitted on the inner and outer surfaces of the bottom 21 of the glass door 2 by the opposite attraction effect of the two strong magnets 513, such that there is no gap between the two first cushioning members 51 and the inner and outer surfaces of the bottom 21 of the glass door 2. The both sides of the two second cushioning members 52 are respectively provided with a convex portion 521, wherein the two convex portions 521 are respectively combined with and connected to the two concave portions 511 of the first cushioning members 51, the other two convex portions 521 are respectively combined with and connected to the two concave portions 421 of the reset device 4 and the two concave portions 81 of the two shells 80, so as to increase the stability of the connection with each other without falling off; and two clamping grooves 522 are respectively provided on upper and lower side of the two second cushioning members 52, and the upper and lower edges of the clamping grooves 522 facing the inner and outer surfaces of the glass door 2 respectively provide an inclined surface 523.

Referring to FIG. 15 and FIG. 16, the reinforced structure 3 is provided with a lock 9 in the locking shell 8. The lock 9 is provided with a rotary lock 91 and a lock sleeve; the rotary lock 91 protrudes from the through hole 82 of one of the two shells 80 and the plurality of fixing pieces 84 are respectively inserted into the plurality of holes 83, so as to fix the lock 9 between the two shells 80 and facilitate a user to open or lock the lock 9 at the bottom 21 of the glass door 2 by means of a key; a plurality of cushions 7 are provided on outer surfaces of the two cushioning materials 5, the locking shell 8 and the reset device 4, and the plurality of cushions 7 are as the plurality of cushions 7 described in FIG. 9, wherein the lengths of the two first gaskets 71 are provided corresponding to outer surfaces of the two first cushioning members 51, wherein the rotary lock 91 protrudes from the notch hole 721 of one of the second gaskets 71, and the lock sleeve is inserted into the notch hole 721 of another one of the second gaskets 71.

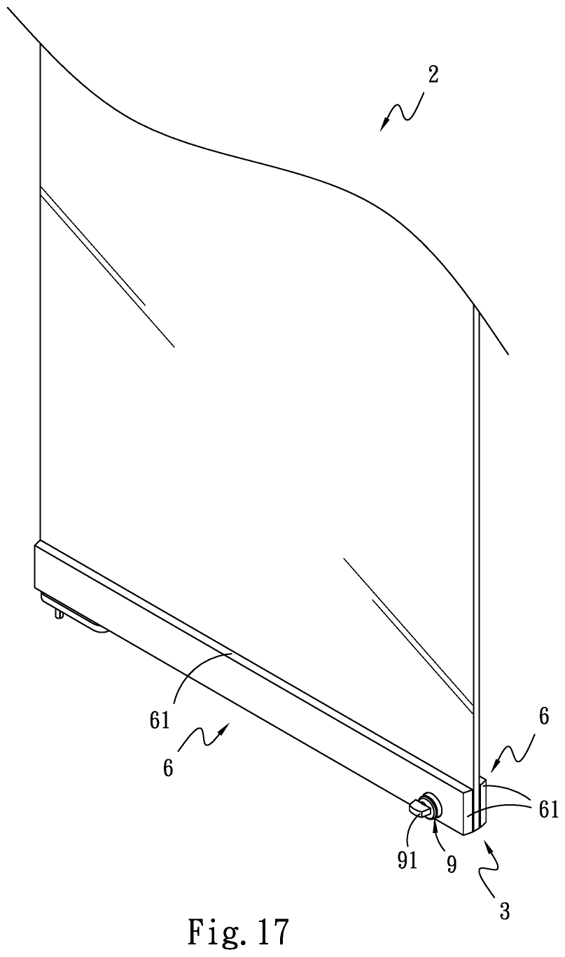

Referring to FIG. 15 and FIG. 16, wherein ends of the two outer protective covers 6 facing the rotary lock 91 and the lock sleeve are provided with an opening 64 for the rotary lock 91 to protrude from the opening 64 of one of the outer protective covers 6 and to be positioned, and the lock sleeve is inserted into and fixed by the opening 64 of the other protective cover 6, as shown in FIG. 17.

Referring to FIG. 15 to FIG. 17, the first embedding notch 211 on one side of the bottom 21 of the glass door 2 assembles the surrounding groove 41 of the reset device 4, the second embedding notch 212 on the other side is used for assembling and fixing the locking shell 8, and the two concave portions 421 of the reset device 4 are respectively embedded with the two convex portions 521 on a side of the two second cushioning members 52, wherein the two convex portions 521 on the other side of the two second cushioning members 52 are respectively embedded with the two concave portions 511 on a side of the two first cushioning members 51; the two concave portions 511 on the other side of the two first cushioning members 51 are respectively embedded with the two convex portions 521 on a side of the other two second cushioning members 52; the two convex portions 521 on the other side of the other two second cushioning members 52 are respectively embedded with the concave portions 81 on a sides of the two shells 80, and the locking shell 8 is assembled and fixed on the second embedding notch 212 on the other side of the bottom 21 of the glass door 2, so that the locking shell 8, the second cushioning members 52, the first cushioning members 51 and the reset device 4 are engaged and embedded integrally; then, the two first gaskets 71 are respectively disposed on outer surfaces of the two first cushioning members 51, the two second gaskets 72 are respectively disposed on outer surfaces of the shell 80, and the third gaskets 73 are respectively disposed on outer surfaces of the reset device 4; and finally, the insertion portions 631 of the outer protective covers 6 are respectively inserted in one of the inclined surfaces 523 of the insertion grooves 522 on upper and lower side of the two second cushioning members 52, so that the insertion portions 631 are clamped in the insertion grooves 522.

With reference to FIG. 3 to FIG. 7, after assembling the invention, the bottom 21 of the glass door 2 is protected from direct impact by the reinforced structure 3, and the user avoids breaking the glass of the glass door 2 when kicking the bottom 21 of the glass door 2 by the foot while walking, kicking by the foot while moving objects, colliding by the wheelchair, or bending easily by wind, so that the bottom 21 of the glass door 2 is reinforced and cushioned, the reinforced structure 3 of the invention can be applied to a wider glass door, and the lengths of the cushioning materials 5 are provided according to the door width of the glass door 2 required by the user, so as to speed up assembling process and save molding costs.

The foregoing is a description of the preferred embodiments of the invention and is provided to enable any person skilled in the art to make or use the invention. It is not intended to limit the scope of the invention. Therefore, all equal changes or modifications made according to the shape, structure and characteristics described in the application scope of the invention shall be included in the application scope of the invention.

What is claimed is:

1. A reinforced structure at a bottom of a glass door, wherein the bottom of the glass door is assembled with the reinforced structure, the reinforced structure comprising:
a reset device assembled on a side of the bottom of the glass door;
two cushioning materials respectively connected and fixed on a side of the reset device, wherein a side of each of the two cushioning materials opposite to the reset device are respectively provided with a locking portion; and
two outer protective covers respectively sleeved on outer surfaces of the reset device and respectively sleeved on outer surfaces of the two cushioning materials.

2. The reinforced structure at the bottom of the glass door according to claim 1, wherein the two locking portions is a locking shell formed by assembling two shells; wherein each of the two cushioning materials is a single cushioning material, or each of the two cushioning materials is connected with one of the two shells, or each of the two cushioning materials is a plurality of cushioning members comprising a first cushioning member and two second cushioning members; and wherein a combination between the two cushioning materials and the reset device, between the two cushioning materials and the two shells, between the first cushioning member and the two second cushioning members, or between the first cushioning members, the two second cushioning members and the two shells is connected by a connection type of embedding, clamping, splicing, lapping, or a combination thereof.

3. The reinforced structure at the bottom of the glass door according to claim 2, wherein the side of the bottom of the glass door is provided with a first embedding notch; or the side of the bottom of the glass door is provided with the first embedding notch, an other side of the bottom of the glass door is provided with a second embedding notch, and the second embedding notch is assembled and fixed with the locking shell; wherein the reset device is provided with a surrounding groove which is assembled with the first embedding notch of the bottom of the glass door, the side of the reset device facing the glass door is separated by the surrounding groove and formed two joining edges, and the two joining edges are respectively provided with a concave portion;
wherein both sides of the two cushioning materials are provided with two clamping grooves respectively located on an upper side and a lower side, and an upper edge and a lower edge of the two clamping grooves facing inner and outer surfaces of the glass door respectively forms an inclined surface; or both an upper side and a lower side of the two second cushioning members provide two clamping groove, the upper edge and the lower edge of the clamping groove facing the inner and outer surfaces of the glass door respectively forms an inclined surface, the two locking portions are respectively provided with a through hole and a plurality of holes, the plurality of holes of the two locking portions are respectively penetrated by a plurality of fixing pieces so as to fix the two cushioning materials, an other side of each of the two cushioning materials facing the concave portions of the two joining edges is respectively provided with a convex portion; the convex portions are embedded and confined in the concave portions, and the two cushioning materials are respectively combined with and connected to the reset device; or the two shells are respectively provided with an another concave portion facing the side of the two cushioning materials; the two shells are respectively provided with a through hole and a plurality of holes, and a plurality of fixing pieces respectively penetrates into the plurality of holes of the two shells to fix the locking shell; or the two cushioning materials are respectively provided with an another convex portion on the side opposite to the reset device, and the convex portions at both sides of the two cushioning materials are respectively embedded and confined in the concave portions of the reset device and the another concave portions of the two shells, the two cushioning materials are respectively combined and connected with the reset device and the locking shells; and a receptacle and a strong magnet therein are provided on an inner surface of each of the two cushioning materials or each of the first cushioning members such that the two cushioning materials or the first cushioning members are closely fitted on the inner and outer surfaces of the bottom of the glass door by each of the strong magnets; and
wherein the two outer protective covers are respectively provided with a frame edge, and a side of the frame edge facing the two cushioning materials is provided with an inner space; and both sides of the inner space are respectively provided with a catching piece, outer ends of the catching pieces are respectively provided with an insertion portion, the insertion portion is slightly curved outwards, and the insertion portions are respectively inserted into and clamped by each of the clamping grooves of the two cushioning materials or the two second cushioning members.

4. The reinforced structure at the bottom of the glass door according to claim 3, wherein a lock is assembled between the two shells, the lock comprises a rotary lock and a lock sleeve, the rotary lock protrudes from the through hole of one of the two shells, and the plurality of fixing pieces are respectively inserted into the plurality of holes of the two shells to fix the lock; and wherein an end of each of the two outer protective covers facing the rotary lock and the lock sleeve is provided with an opening, the rotary lock protrudes from and is positioned by one of the openings of the two outer protective covers, and the lock sleeve is inserted and fixed by another one of the openings of the two outer protective covers.

5. The reinforced structure at the bottom of the glass door according to claim 3, wherein both sides of the first cushioning members are respectively provided with a concave portion, and both sides of the two second cushioning members are respectively provided with a convex portion; several of the convex portions are embedded and confined in the concave portions of the first cushioning members, the two second cushioning members are respectively combined with and connected to the first cushioning members; and several of the convex portions are embedded and confined in the concave portions of the reset device and the concave portions of the two shells, the two second cushioning members are respectively combined with and connected to the reset device and the two shells.

6. The reinforced structure at the bottom of the glass door according to claim 3, wherein the reinforced structure further comprises two cushions respectively provided on outer surfaces of the reset device and the two cushioning materials, or on outer surfaces of the reset device, the two cushioning materials and the two shells.

7. The reinforced structure at the bottom of the glass door according to claim 6, wherein the two cushions are single pieces, lengths of the two cushions are respectively provided with the outer surfaces of the reset device and the two cushioning materials; the two cushions are respectively provided with a notch hole and a plurality of fixing holes, the notch holes respectively correspond to the through holes of the locking portions or the through holes of the two shells, and the plurality of fixing holes respectively correspond to the plurality of holes of the locking portions or the plurality of holes of the two shells; two embedding grooves are respectively provided on an upper side and a lower side and are provided on both sides of the two cushions, the two embedding grooves corresponds to the two clamping grooves of the two cushioning materials, the insertion portions of the two catching pieces are respectively inserted into and clamped by each of the two embedding grooves of the two cushions and each of the two clamping grooves of the two cushioning materials.

8. The reinforced structure at the bottom of the glass door according to claim 6, wherein each of the two cushions is a plurality of pieces, the plurality of pieces comprise a first gasket, a second gasket and at least one third gasket; a length of the first gasket is provided according to a length of outer surface of the two cushioning materials, a length of the second gasket is provided according to a length of outer surfaces of the locking portions of the two cushioning materials or outer surfaces of the two shells; the second gasket is provided with a notch hole and a plurality of fixing holes, the notch holes respectively correspond to the through holes of the locking portions or the through holes of the two shells, and the plurality of fixing holes respectively correspond to the plurality of holes of the locking portions or the plurality of holes of the two shells; a length and a position of the third gasket are provided according to outer surface of the reset device; and two embedding grooves are respectively provided on an upper side and a lower side and are provided on both sides of the first gaskets, the two embedding grooves corresponds to the two clamping grooves of the two cushioning materials, the insertion portions of the two catching pieces are respectively inserted into and clamped by each of the two embedding grooves of the first gaskets and each of the two clamping grooves of the two cushioning materials.

9. The reinforced structure at the bottom of the glass door according to claim 1, wherein the two cushioning materials are made of a plastic material.
